(19) United States
(12) Patent Application Publication
(10) Pub. No.: US 2020/0080024 A1
(43) Pub. Date: Mar. 12, 2020

(54) METHOD FOR PRODUCING AROMA COMPOSITION FROM ANIMAL OR PLANT MATERIAL AND APPARATUS FOR COLLECTING AROMA FROM ANIMAL AND PLANT MATERIAL

(71) Applicant: T. HASEGAWA CO., LTD., Tokyo (JP)

(72) Inventors: Koji MURAI, Nakahara-ku, Kawasaki-shi, Kanagawa (JP); Yoshiyuki MISUMI, Nakahara-ku, Kawasaki-shi, Kanagawa (JP); Takeshi WATANABE, Nakahara-ku, Kawasaki-shi, Kanagawa (JP); Takayuki KANEKO, Fukaya-shi, Saitama (JP)

(21) Appl. No.: 16/468,958

(22) PCT Filed: Dec. 13, 2017
(86) PCT No.: PCT/JP2017/044666

§ 371 Date: Jun. 12, 2019

(30) Foreign Application Priority Data
Dec. 16, 2016 (JP) 2016-244868

(51) Int. Cl. C11B 9/02; B01J 20/26; A23D 9/00; A23L 27/10; B01D 53/12; B01D 53/04; A23G 1/56

(52) U.S. Cl. CPC C11B 9/02; B01J 20/261; A23D 9/00; A23L 27/115; A23V 2002/00; B01D 53/04; A23G 1/56; B01D 2253/202; B01D 53/12

(57) ABSTRACT

A method for producing an aroma composition from an animal or plant material, including fragmenting an animal or plant material to give a crude fragmented pieces of the material that contains minor fragments, removing minor fragments from a gas that contains aroma compounds emitted from the material in fragmenting the material and minor fragments, applying the gas from which minor fragments have been removed to an adsorbent to thereby make the aroma compounds adsorbed by the adsorbent, and collecting the aroma compounds from the adsorbent to prepare an aroma composition containing the aroma compounds. The adsorbent is held in an adsorbent holder in an aroma compound adsorbing device, and the adsorbent holder has a mesh lid at both ends thereof in the gas flowing direction therethrough.

### TECHNICAL FIELD

The present invention relates to a method for producing an aroma composition from an animal or plant material and to an apparatus for collecting aroma from an animal or plant material.

### BACKGROUND ART

An aroma composition is used as a food flavoring or a fragrance. An aroma composition for food and drink can be prepared from a natural flavoring, a synthetic chemical for flavorings and/or a blended composition for flavorings composed of the former two, and with the recent tendency toward consumer needs for natural feelings, a flavoring is also desired to be a natural flavoring or a flavoring having a feel of nature, and various production methods are now under investigation.

Various methods are known as a method for producing an aroma composition (see PTL 1).

For example, as a method for producing a flavoring composition from an animal or plant material such as coffee, red tea, green tea, oolong tea, etc, PTL 1 describes a method for producing a coffee flavoring by trapping a volatile coffee flavor component-containing vapor that has been released by introducing a steam and/or an inert gas toward a ground roasted coffee, in a solution of caramel or the like; a method of fractionating a condensed water obtained by steam distillation of roasted coffee; a method of bringing a flavor component-containing distillation liquid obtained through distillation of fruit juice or coffee into contact with a reversed-phase partition-type adsorbent followed by extracting it with a solvent; a method for formulating a coffee flavoring having both an aroma component and a taste component, which contains a coffee flavor raw material obtained in a steam distillation in an aqueous layer and contains a coffee oil obtained in expressed oil collection or supercritical fluid extraction as an oil phase; and a method for producing a tea flavoring by bringing a distillate obtained through steam distillation of tea leaves into contact with tea leaves to remove the heating distillation smell from the tea distillate.

According to PTL 1, the steam distillation method is a method where a steam vapor is introduced into a raw material and the aroma components to evaporate along with the steam are condensed with the steam, and depending on the type of the raw material to be processed, any distillation method of increased pressure steam distillation, atmospheric steam distillation or reduced pressure steam distillation is employable for the method, as so described therein.

When animal and plant materials are fragmented by grinding, fracturing, mincing, powdering or flaking, an excellent aroma peculiar to each raw material may be often emitted. A flavoring capable of imparting such an aroma is desired for years. PTLs 2 to 6 describe a method of using roasted coffee beans, as a kind of animal or plant materials, and using an aroma emitted in grinding the roasted coffee beans.

### CITATION LIST

### Patent Literature

PTL 1: JP 2003-33137 A
PTL 2: JP 3719995 B1
PTL 3: JP 4182471 B1
PTL 4: JP 4308724 B1
PTL 5: JP 4745591 B1
PTL 6: JP 2003-144053 A

### SUMMARY OF INVENTION

### Technical Problem

In the methods described in PTLs 2 to 5, the gas that contains aroma components emitted in grinding an animal or plant material (grinding gas) is directly introduced into a solvent, e.g., water or a coffee oil, to produce an aroma composition.

In the method of PTL 6, the gas from grinding an animal or plant material is compressed under pressure and stored in an aluminum container.

However, for the aroma compositions to be obtained according to the methods described in PTLs 2 to 6, the collecting efficiency is not high since the aroma compound-containing gas is made to flow through a solvent, and the compositions could not sufficiently reproduce the fresh flavor in fragmenting an animal or plant material.

In addition, the methods described in PTLs 2 to 6 use an inert gas and require special devices such as closed fragmenting machines, passages to solvent layers, as well as solvent layers and constant-temperature tanks, therefore increasing the capital investment and making it difficult to put them into practical use.

An object of the present invention is to provide a method for producing an aroma composition from an animal or plant material using an ordinary grinding machine and capable of being put into practical use without requiring any great capital investment and serious load on equipments, and the aroma composition thus produced according to the method can give an aroma that is perceivable in fragmenting an animal or plant material.

Another object of the present invention is to provide an apparatus for collecting an aroma from animal and plant materials, which, using an ordinary grinding machine, can be put into practical use without requiring any additional great capital investment and serious load on equipments and can produce an aroma composition capable of giving an aroma that is perceivable in fragmenting an animal or plant material.

### Solution to Problem

The present inventors have made assiduous studies for the purpose of solving the above-mentioned problems, and, as a result, have found that, as a method wholly different from the methods described in PTLs 1 to 6, when, from a gas that contains aroma compounds that are emitted from an animal or plant material in fragmenting the animal or plant material, an excessively finely fragmented pieces and thin flakes of the animal or plant material, and fragmented pieces and thin flakes derived from any other foreign substances (hereinafter these are collectively referred to as “minor fragments”), the minor fragments are removed, and thereafter the aroma compounds that are emitted in fragmenting the animal or plant material are adsorbed by an adsorbent and collected, then the aroma compounds can be effectively collected and a natural aroma composition capable of giving an aroma that is perceivable in fragmenting the animal or plant material can be produced efficiently without forcedly requiring any further great capital investment over an ordinary fragmenting apparatus (for example, a conventional fragmenting apparatus), and have completed the present invention.

The present invention as a specific means for solving the above-mentioned problems and preferred embodiments thereof are as described below.

[1] A method for producing an aroma composition from an animal or plant material, which includes:

a step of fragmenting the animal or plant material to give crude fragmented pieces of the animal or plant material, the crude fragmented pieces containing minor fragments, and includes:

a step of removing the minor fragments from a gas that contains aroma compounds that are emitted from the animal or plant material in fragmenting the animal or plant material and contains the minor fragments,

an adsorbing step of introducing the gas from which the minor fragments have been removed into an adsorbent to thereby make the aroma compounds adsorbed by the adsorbent, and

a collecting step of collecting the aroma compounds from the adsorbent to prepare an aroma composition containing the aroma compounds, and in which:

the adsorbent is held in an adsorbent holder in an aroma compound adsorbing device, and the adsorbent holder has a mesh lid at both ends thereof in the gas flowing direction therethrough.

[2] The method for producing an aroma composition from an animal or plant material according to [1], wherein a step of removing the minor fragments from the crude fragmented pieces of the animal or plant material is carried out prior to the step of removing the minor fragments from the gas.
[3] The method for producing an aroma composition from an animal or plant material according to [1] or [2], wherein the step of removing the minor fragments is carried out in a minor fragments removing device.
[4] The method for producing an aroma composition from an animal or plant material according to any one of[l] to [3], wherein the gas flow is generated using a gas flow generating device.
[5] The method for producing an aroma composition from an animal or plant material according to any one of [1] to [4], wherein:

in the flow channel for the gas from which the minor fragments have been removed, a guide path that branches from the flow channel and is communicated with the aroma compound adsorbing device is provided, and

only a part of the gas from which the minor fragments have been removed is made to flow through the guide path and the adsorbent to collect the aroma compounds.

[6] The method for producing an aroma composition from an animal or plant material according to any one of [1] to [5], wherein the adsorbent is one or more selected from a styrene-divinylbenzene copolymer, an ethylvinylbenzene-divinylbenzene copolymer, a 2,6-diphenyl-9-phenyl oxide polymer, a condensation polymer of a methacrylic acid and a diol, and a modified silica gel.
[7] The method for producing an aroma composition from an animal or plant material according to any one of [1] to [6], wherein the aroma compounds are desorbed from the adsorbent using an organic solvent in the collecting step.
[8] The method for producing an aroma composition from an animal or plant material according to [7], wherein the organic solvent is ethanol or propylene glycol.
[9] The method for producing an aroma composition from an animal or plant material according to any one of [1] to [8], wherein the linear speed of the gas flowing into the absorbent is within a range of 0.1 to 35.0 m/s.
[10] The method for producing an aroma composition from an animal or plant material according to any one of [1] to [9], wherein the gas flowing direction is substantially an opposite direction to the direction of gravitational force.
[11] The method for producing an aroma composition from an animal or plant material according to any one of [1] to [10], wherein the aroma compound adsorbing device is a fluidized-bed column that holds the adsorbent therein.
[12] The method for producing an aroma composition from an animal or plant material according to any one of [1] to [11], which includes a step of controlling the linear speed of the gas flowing into the adsorbent.
[13] The method for producing an aroma composition from an animal or plant material according [12], wherein the linear speed of the gas flowing into the adsorbent is controlled using a blower or a suction pump.
[14] A food or drink containing an aroma composition produced according to the production method of any one of [1] to [13].
[15] An apparatus for collecting aroma from an animal or plant material, which includes:

a device for fragmenting the animal or plant material,

a first flow channel which is communicated with the fragmenting device and through which a gas can flow, the gas containing aroma compounds emitted in fragmenting the animal or plant material and containing minor fragments,

a minor fragments removing device communicated with the first flow channel,

a second flow channel which is communicated with the minor fragments removing device and through which the gas, from which minor fragments have been removed, can flow,

an aroma compound adsorbing device communicated with the second flow channel, and

a gas flow generating device that generates a gas flow continuing from the fragmenting device to the aroma compound adsorbing device, and in which:

the aroma compound adsorbing device has an adsorbent holder that holds an adsorbent therein, and the adsorbent holder has a mesh lid at both ends thereof in the gas flowing direction therethrough.

[16] The apparatus for collecting aroma from an animal or plant material according to [15], which further includes a guide path branched from the second flow channel, and in which the guide path is communicated with the aroma compound adsorbing device.
[17] The apparatus for collecting aroma from an animal or plant material according to [15] or [16], which further includes a minor fragments preremoving device between the fragmenting device and the first flow channel.
[18] The apparatus for collecting aroma from an animal or plant material according to any one of [15] to [17], wherein the gas flowing direction through the adsorbent is substantially an opposite direction to the direction of gravitational force.
[19] The apparatus for collecting aroma from an animal or plant material according to any one of [15] to [18], wherein the aroma compound adsorbing device is a fluidized-bed column that holds the adsorbent therein.
[20] The apparatus for collecting aroma from an animal or plant material according to any one of [15] to [19], which further includes a linear speed controlling device for controlling the linear speed of the gas from which the minor fragments have been removed.
[21] The apparatus for collecting aroma from an animal or plant material according to any one of [15] to [20], wherein the linear speed controlling device is a blower or a suction pump.
[22] The apparatus for collecting aroma from an animal or plant material according to any one of [15] to [21], wherein the diameter of the cross section of the adsorbent part held in the adsorbent holder is 10 mm or more.
[23] The apparatus for collecting aroma from an animal or plant material according to any one of [15] to [22], wherein the length in the gas flowing direction of the adsorbent part held in the adsorbent holder is 1000 mm or less.

### Effects of Invention

According to the present invention, there can be provided a method for producing an aroma composition from an animal or plant material using an ordinary fragmenting machine without requiring any additional great capital investment and serious load on equipments, and the aroma composition thus produced according to the method can give an aroma that is emitted in fragmenting the animal or plant material, that is, such a fresh aroma that is perceivable in fragmenting the animal or plant material. Though being a natural aroma composition, the aroma composition of the present invention can enhance the top aroma derived from the animal or plant material.

Also according to the present invention, there can be provided an apparatus for collecting aroma from an animal or plant material, which, using an ordinary fragmenting machine and without requiring any additional great capital investment and serious load on equipments, can produce an aroma composition capable of giving an aroma that is perceivable in fragmenting the animal or plant material.

### BRIEF DESCRIPTION OF DRAWINGS

FIG. 1 is a schematic view showing an example of an aroma collecting apparatus of the present invention.

FIG. 2 is a schematic view showing another example of an aroma collecting apparatus of the present invention.

FIG. 3 is a cross-sectional schematic view of an adsorbent holder in the present invention.

FIG. 4 is a performance diagram of an ordinary gas flow generator.

### DESCRIPTION OF EMBODIMENTS

The present invention is described in detail hereinunder. The description of the constitutive elements of the invention given hereinunder is for some typical embodiments or examples of the invention, to which, however, the invention should not be limited. In this description, the numerical range expressed by the wording “a number to another number” means the range that falls between the former number indicating the lower limit of the range and the latter number indicating the upper limit thereof.

[Method for Producing Aroma Composition from Animal or Plant Material]

The method for producing an aroma composition from an animal or plant material of the present invention (hereinafter this may be referred to as the production method of the present invention) includes a step of fragmenting the animal or plant material to give crude fragmented pieces of the animal or plant material, the crude fragmented pieces containing minor fragments, and includes:

a step of removing minor fragments from a gas that contains aroma compounds that are emitted from the animal or plant materials in fragmenting the animal or plant materials and contain the minor fragments,

an adsorbing step of introducing the gas from which the minor fragments have been removed into an adsorbent to thereby make the aroma compounds adsorbed by the adsorbent, and

a collecting step of collecting the aroma compounds from the adsorbent to prepare an aroma composition containing the aroma compounds, and in which:

the adsorbent is held in an adsorbent holder in an aroma compound adsorbing device, and the adsorbent holder has a mesh lid at both ends thereof in the gas flowing direction therethrough (see FIG. 3, the arrow in the drawing indicates the gas flowing direction).

The details of the mesh lid are described below.

According to the above-mentioned constitution, an aroma composition that gives an aroma perceivable in fragmenting an animal or plant material can be produced from an animal or plant material using an ordinary fragmenting device and without requiring any additional great capital investment and serious load on equipments.

When animal or plant materials are fragmented into a desired size, in addition to fragmented pieces fragmented into a desired size, there are formed any one or more of fragmented pieces and thin flakes derived from animal and plant materials which do not meet the desired size and fragmented pieces, thin flakes derived from any other foreign substances (in this description, these are collectively referred to as “minor fragments”), and the minor fragments are light and scatter. In industrial fragmenting of animal or plant materials, at least a part of the minor fragments scatter and mix in an exhaust gas flow generated in the fragmenting device. Heretofore, the exhaust gas flow has been discharged out of the device as it is, after the minor fragments have been appropriately removed therefrom.

Here, in the present invention, differing from PTLs 2 to 6, an adsorbent held in an aroma compound adsorbing device is used in place of a solvent (liquid) for collecting aroma compounds. If an exhaust gas flow containing minor fragments therein is, as it is, directly applied to an adsorbent, it is considered that the minor fragments may clog a mesh lid and may also clog fine pores of an adsorbent and even fine voids between adsorbent particles to make the exhaust gas flow difficultly flow therethrough so that the exhaust system of the fragmenting device (exhaust ventilation by the gas flow generating device to be mentioned below in the present invention) will be overloaded (pressured). As opposed to this, the production method of the present invention employs a method where, after minor fragments have been removed from the exhaust gas flow, the resultant exhaust gas flow is introduced into an adsorbent to make the adsorbent adsorb aroma compounds, and according to the production method of the present invention, therefore, aroma compounds contained in the exhaust gas flow can be adsorbed by the adsorbent with no risk of clogging of the mesh lid and the adsorbent and no risk of giving a load to the device. In addition, owing to this clogging prevention, the aroma compounds can be efficiently adsorbed by the adsorbent.

Referring to exhaust system performance of an ordinary grinding device, when an adsorbent is held in an adsorbent holder arranged in the flow channel of an exhaust gas flow in the device, a load over an allowable range may be given to the device owing to the resistance of the adsorbent to the exhaust gas flow (in this description, this may be simply referred to as a load). Consequently, in the present invention, a means of suppressing the resistance owing to the adsorbent may be employed. For example, the length in the flowing direction of an exhaust gas flow (also referred to as the gas flowing direction) in the part occupied by the adsorbent held in the adsorbent holder (hereinafter in this description, this may be referred to as an adsorbent part, or a held adsorbent part) is reduced, or a flow channel that is branched from the flow channel of an exhaust gas flow and holds an adsorbent therein is arranged so as to collect aroma compounds from a part of the exhaust gas flow. Apart from these exemplifications, the resistance of adsorbent may also be suppressed by enhancing the mobility of the adsorbent held in the device (for example, using a so-called “fluidized-bed column”). Further, a blower or a suction pump may be additionally used for the gas introduction into the adsorbent over the resistance thereof.

Preferred embodiments of the production method of the present invention are described below.

### <Step of Preparing Crude Fragmented Pieces of Animal and Plant Materials>

The production method of the present invention includes a step of fragmenting an animal or plant material to give crude fragmented pieces of the animal and plant material, wherein the crude fragmented pieces contain minor fragments.

Preferably, the step of fragmenting an animal or plant material to give crude fragmented pieces of the animal and plant material is carried out prior to any other step.

In this description, “fragmenting” means that animal or plant material is processed into small fragments having a desired size according to any arbitrary method of grinding, fracturing, mincing, powdering or flaking the material. In the fragmenting step, minor fragments that are derived from the animal or plant material or foreign substances and are smaller than the desired size are generally formed.

The method of fragmenting an animal or plant material is not specifically limited, and any known method is employable. For example, any arbitrary apparatus capable of fragmenting animal or plant materials, for example, a grinding device such as a roller mill, a jet mill, a hammer mill, a rotary mill or a shaking mill, as well as a flaking machine or a powdering machine may be used in accordance with the intended object.

Not specifically limited, the fragmenting speed for an animal or plant material may be set arbitrarily according to the type of the animal or plant material, for example, 1 to 500 kg/h.

Also not specifically limited, the fragmenting size of an animal or plant material may be set arbitrarily according to the animal or plant material. For example, the size may be 0.08 to 3 mm or so.

The animal or plant material to be processed in the fragmenting step may have an original size at the time when they are obtained, but may be prefragmented to have a size larger than the intended size.

### (Animal or Plant Material)

Not specifically limited, the animal or plant material for use in the production method of the present invention may be any ones capable of being fragmented and capable of being used for production of any arbitrary products such as foods and drinks, cosmetics, health and hygiene products and medicines.

The animal or plant material may be those capable of being fragmented to be drunk or eaten as such, or may be those capable of being used for production of any arbitrary products such as foods and drinks, cosmetics, health and hygiene products and medicines. Preferred examples thereof include roasted animal or plant materials.

Specifically, examples of the animal or plant material include, though not limited thereto, nuts (peanuts, almonds, cashew nuts, walnuts, etc.), tea (roasted green tea, powdered green tea, etc.), dried products (dried animal materials such as dried small sardines, and dried plant materials such as dried mushrooms), dried fishes (various dried bonitos), other dried fishes than dried bonitos (dried Souda bonitos, dried mackerels, dried tunas, dried round herrings, dried sardines, dried sauries, etc.), buckwheat, spices (pepper, thyme, capsicum, cinnamon, turmeric, etc.), sesames, soybeans, lavers, and herbs.

### (Crude Fragmented Pieces of Animal and Plant Material)

Preferably, the crude fragmented pieces of an animal or plant material contain the above-mentioned minor fragments and fragmented pieces of the animal or plant material fragmented into a desired size.

Preferably, the minor fragments are removed from the gas that contains aroma compounds that are emitted from an animal or plant material in fragmenting the animal or plant material. Specifically, it is preferable that the minor fragments pass through a first flow channel to be mentioned in detail hereinunder, along with the gas, and are removed from the gas in a minor fragments removing device.

### (Aroma Compound Emitted in Fragmenting Animal or Plant Materials)

The aroma compound emitted from an animal or plant material in fragmenting the animal and plant material includes one or plural compounds.

### <Step of Preremoving Minor Fragments>

In the production method of the present invention, preferably, a step of removing minor fragments from the crude fragmented pieces of an animal or plant material is carried out prior to the step of removing minor fragments from the gas mentioned above. The minor fragments may be removed partly, but substantially the whole thereof may be removed.

The step of removing minor fragments from the crude fragmented pieces of an animal or plant material may be carried out using any known minor fragments removing device, for example, a classification device such as a shaking sieve or a wind classification device. A classification device using a shaking sieve is preferred. For example, using a sieve having a desired opening, minor fragments smaller than the opening may be removed.

### <Step of Removing Minor Fragments>

The production method of the present invention includes a step of removing minor fragments from a gas that contains aroma compounds that are emitted from an animal or plant material in fragmenting the animal or plant material and contains the minor fragments. Not removed, the minor fragments may partly remain, but preferably, the minor fragments are removed substantially wholly.

The step of removing minor fragments is not specifically limited, and may be carried out in any known method.

In the production method of the present invention, preferably, the step of removing minor fragments is carried out in a minor fragments removing device to be mentioned in detail hereinunder.

The details of the minor fragments removing device are given in the section of the aroma collecting apparatus of the present invention.

### <Adsorbing Step>

The production method of the present invention includes an adsorbing step of introducing the gas from which minor fragments have been removed into an adsorbent to thereby make the aroma compounds that are contained in the gas adsorbed by the adsorbent. Here, the adsorbent is held in an adsorbent holder arranged in an aroma compound adsorbing device, and the adsorbent holder has a mesh lid at both ends thereof in the gas flowing direction therethrough.

The adsorbent amount may be, not specifically limited, an amount capable of being held in the adsorbent holder. The volume (bulk volume) of the adsorbent to be used may be the same as the volume of the adsorbent holder, or may be less than it. In other words, the adsorbent may be filled (roughly filled or densely filled) in the adsorbent holder, or there may exist some void space in the adsorbent holder that holds an adsorbent therein.

The gas flowing direction may be at any desired angle relative to the installation surface on which the aroma collecting apparatus is installed (or the ground plane in the case where the aroma collecting apparatus is installed on the ground), and may be, for example, parallel or vertical thereto. Also, for example, the gas flowing direction may be the direction approaching to or leaving from the installation surface of the aroma collecting apparatus. In other words, the gas flowing direction through the adsorbent may be a substantially opposite direction to the direction of gravitational force, or substantially the same direction thereto, or may be perpendicular thereto, or may be at any other angle thereto. In the case where the gas is made to flow into or through the adsorbent in a substantially opposite direction to the direction of gravitational force, the volume (bulk volume) of the adsorbent to be used may be smaller than the volume of the adsorbent holder so that the aroma compound adsorbing device may be a so-called fluidized-bed column and the resistance of the adsorbent to the gas flow may be thereby reduced.

In the production method of the present invention, preferably, a gas flow is generated using a gas flow generating device and the gas from which minor fragments have been removed is introduced into the adsorbent. Using both a flow rate controlling device and a gas flow generating device, the gas flow rate and pressure may be increased. By the combined use, the gas may be made to flow exceeding the resistance of the adsorbent to the gas flow.

The details of the gas flow generating device and the gas flow rate controlling device are described in the section of the aroma collecting apparatus of the present invention given hereinunder.

In the production method of the present invention, preferably, a guide path having an adsorbent arranged therein may be so arranged as to be branched from the flow channel of the gas from which minor fragments have been removed, so that only a part of the gas from which minor fragments have been removed could be made to flow into or through the guide path and further to flow through the adsorbent to thereby collect aroma compounds.

The details of the guide path are described in the section of the aroma collecting apparatus of the present invention.

### (Adsorbent)

The adsorbent is not specifically limited. As the adsorbent, a synthetic adsorbent or an activated carbon and any other adsorbent are employable. Preferably, a synthetic adsorbent is used from the viewpoint that it is readily desorbable.

Preferably, the adsorbent is one or more selected from a styrene-divinylbenzene copolymer, an ethylvinylbenzene-divinylbenzene copolymer, a 2,6-diphenyl-9-phenyl oxide polymer, a condensation polymer of a methacrylic acid and a diol, and a modified silica gel. The modified silica gel is a chemically-bonded silica gel prepared by chemically bonding a reactive substance such as an alcohol, an amine, a silane or the like to the surface of a silica gel by utilizing the reactivity of the silanol group with the reactive substance. Above all, a styrene-divinylbenzene copolymer is preferred.

The adsorbent is preferably a porous polymer resin. The surface area of the adsorbent is, for example, preferably about 300 m²/g or more, more preferably about 500 m²/g or more. Also preferably, the pore size distribution of the adsorbent is about 10 Å to about 500 Å.

Not specifically limited, the shape of the adsorbent is granular. Also not specifically limited, the average particle diameter of the granular adsorbent may be, for example, within a range of 0.1 to 20 mm, or 0.1 to 1 mm.

Examples of the porous polymer resin satisfying the above-mentioned requirements include an HP resin (manufactured by Mitsubishi Chemical Corporation), an SP resin of a styrene-divinylbenzene copolymer (manufactured by Mitsubishi Chemical Corporation), and XAD-4 (manufactured by Rohm & Haas Inc.), and these are readily available on the market. Also commercial products of a methacrylate resin, for example, XAD-7 and XAD-8 (manufactured by Rohm & Haas Inc.) are also available.

Preferred examples of the SP resin include Sepabeads SP-70 and SP-207.

The processing means for introducing the gas from which minor fragments have been removed into the adsorbent so as to make aroma compounds adsorbed by the adsorbent may be any of a batch system or a column system. From the viewpoint of workability, a column system is preferably employed. Regarding adsorbing method using a column system device, for example, the gas is introduced into a column filled with the above-mentioned adsorbent so that aroma compounds may be adsorbed by the adsorbent. The direction of the gas flowing into or through the adsorbent may be any desired direction relative to the direction of gravitational force, and for example, though not limited thereto, the direction may be substantially the same direction as or substantially an opposite direction to the direction of gravitational force.

By controlling the particle size and the amount of the adsorbent, the adsorbent holder may be made to have some void space therein, and further, the gas may be made to flow thereinto or therethrough in a substantially opposite direction to the direction of gravitational force, like in a fluidized-bed column.

For preventing it from cracking, preferably, the adsorbent is made to absorb pure water and, before being completely dried, it is held in the aroma compound adsorbing device.

The gas flow amount in introducing the gas from which minor fragments have been removed into the adsorbent is, though not specifically limited thereto, for example, preferably 0.1 to 1000 times by volume of the adsorbent.

Not specifically limited, the flow rate of the gas to flow through the adsorbent (the flowing gas speed) may be appropriately set depending on the adsorbent amount, the length in the gas flowing direction of the adsorbent part, and the performance of the gas flow generating device and the flow rate controlling device to be mentioned hereinunder. For example, the gas flow rate (flowing gas speed) of the gas flowing into the adsorbent is preferably 0.1 to 10.0 L/min, more preferably 0.5 to 7.0 L/min, and even more preferably 1.0 to 5.0 L/min.

A preferred range of the gas introduction time through the adsorbent may be set depending on the gas flow amount in introducing the gas from which minor fragments have been removed into the adsorbent and on the gas flow rate flowing into the adsorbent.

In the production method of the present invention, the flow rate (linear speed) of the gas flowing into the adsorbent may be appropriately set depending on the adsorbent amount, the length of the gas flowing direction in the adsorbent part, the inner diameter of the second flow channel to be mentioned hereinunder, and the performance of the gas flow generating device and the flow rate controlling device also to be mentioned hereinunder, and is not specifically limited. For example, the flow rate is preferably within a range of 1.0 to 35.0 m/s, more preferably within a range of 2.0 to 20.0 m/s, and even more preferably within a range of 3.0 to 10.0 m/s.

### <Step of Controlling Gas Linear Speed>

Preferably, the production method of the present invention includes a step of controlling the linear speed of the gas flowing into the adsorbent, from the viewpoint of realizing adsorbability over the resistance of the adsorbent and from the viewpoint of reducing the load on the gas flow generating device to be mentioned hereinunder, even when a large amount of an adsorbent is held (or filled) in the aroma compound adsorbing device.

In the production method of the present invention, the linear speed of the gas to flow into the adsorbent may be controlled using any known gas flow generating device, for example, a suction pump or a blower.

For example, the linear speed of the gas flowing into the adsorbent may be in any desired ratio relative to the linear speed of the gas flowing through the second flow channel, and relative to the upper limit referred to as 100%, the linear speed may be 90% or more, 80% or more, 70% or more, 60% or more, 50% or more, 40% or more, 30% or more, 20% or more, 10% or more, 5% or more, or even 1% or more. Concretely, the range includes 0.05 to 35 m/s, 0.08 to 20 m/s, 1.0 to 10 m/s, 1.0 to 5 m/s, or 1.0 to 2 m/s, but is not specifically limited thereto.

For example, preferably, the ratio of the linear speed of the gas flowing into the adsorbent relative to the linear speed of the gas flowing into the second flow channel is controlled in accordance with the performance of the gas flow generating device to be mentioned below. According to such controlling, the load on the gas flow generating device can be reduced.

### <Collecting Step>

The production method of the present invention includes a collecting step of collecting aroma compounds from the adsorbent to prepare an aroma composition containing the aroma compounds.

In the production method of the present invention, aroma compounds are preferably desorbed from the adsorbent using an organic solvent and collected in the collecting step.

Before desorbing aroma compounds from the adsorbent using an organic solvent, the adsorbent may be washed with water.

An organic solvent may be used here, including alcohols, oils and fats.

Not specifically limited, the alcohols for use in the collection step are preferably ethanol or propylene glycol, and more preferably propylene glycol from the viewpoint of safety (that is, hardly ignitable). Not adhering to any theory, alcohols such as propylene glycol and ethanol can acetalize a part of the collected aroma compound(s) (for PG acetalization, or diethyl acetalization) and, as a result, it is expected to enhance the aroma expression performance of the aroma compounds. A mixture of two or more aroma compositions for which different alcohols are used individually may be used as the aroma composition of the present invention. For example, an aroma composition obtained using propylene glycol and an aroma composition obtained using ethanol may be mixed in any desired ratio (within a range where the ratio of the aroma composition obtained using ethanol is 0.1 to 10, 0.2 to 5, 0.5 to 3, or 0.8 to 2 relative to 1 part by mass of the aroma composition obtained using propylene glycol, or as a ratio by mass, the ratio of the aroma composition obtained using propylene glycol to the aroma composition obtained using ethanol is about 1/1, 2/1, 3/2 or 2/3).

An aqueous alcohol solution of 50 to 100% by mass may be used. For ethanol, hydrous ethanol having an ethanol concentration of 50 to 95% by mass is preferably used; and for PG, 100 mass % PG is preferably used.

In the case where columns are used, the flow rate of alcohol to pass through them is preferably SV=0.1 to 20.

The amount of alcohol to be used is not specifically limited, and the flow amount thereof is preferably 1 to 100 times by volume of the adsorbent, more preferably 3 to 40 times, even more preferably 5 to 20 times thereof.

By eluting the aroma compound adsorbed by the adsorbent with an alcohol or the like, a water-soluble aroma composition (aroma condensate) can be obtained.

Not specifically limited, examples of the fats and oils for use for desorption include vegetable fats and oils such as soybean oil, rice oil, sesame oil, peanut oil, corn oil, rapeseed oil, coconut oil and palm oil, and hardened fats and oils thereof; animal fats and oils such as beef tallow, lard and fish oil, and hardened fats and oils thereof; and middle chain fatty acid triglycerides (hereinafter this may be referred to as MCT). From the viewpoint the stability of the aroma composition to be obtained, MCT is preferred. Examples of MCT include triglycerides of middle acid fatty acid having 6 to 12 carbon atoms, such as caproic acid triglyceride, caprylic acid triglyceride, capric acid triglyceride, lauric acid triglyceride and mixtures thereof. In particular, caprylic acid triglyceride, capric acid triglyceride and mixtures thereof are preferred. These MCT mixtures are inexpensive and are easily available on the market. A mixture of two or more aroma compositions each using different fats and oils may be used as an aroma composition of the present invention.

The amount of the fats and oils to be used herein differs depending on the type of the raw material and the aroma component concentration in the gas. Desorption may be carried out under a static condition, and the desorption temperature and the desorption time may be appropriately selected. For example, a desorption time falling within a range of 5 minutes to 2 hours at a temperature ranging from 10 to 80° C. may be referred to as one example of the operation. After desorption, the resultant desorbed liquid is kept statically, and may be subjected to separation between the oil part and the aqueous part according to an ordinary separation method of, for example, decantation or centrifugation. A component of fats and oils may be further added to the aqueous part for extraction to thereby efficiently collect the aroma components of interest. The resultant oil part may be dewatered, for example, using a dewatering agent such as anhydrous sodium sulfate, and may be filtered according to a clarification filtering means using, for example, filter paper to give an oil-soluble aroma composition.

### <Reuse and Washing of Adsorbent>

Regarding adsorbent, the pressure of the liquid flowing through the adsorbent before desorption with an organic solvent and that after desorption are compared, and when the two are close to each other (for example, not more than 2 times), no clogging has occurred, or clogging is on an ignorable level, and it is judged that the adsorbent on that level is reusable without washing. The method of maintaining the aroma collecting apparatus may include a step of comparing the pressures of the liquid flowing through the adsorbent between before and after the desorption with an organic solvent, and confirming as to whether or not the pressures are close to each other. Specifically, it is preferable that, before and after desorption, the device is purged with pure water, then ultrapure water is introduced thereinto at SV=10 or so and the pressure of the water flow is measured, and then the pressure after desorption is calculated relative to the pressure before desorption.

On the other hand, the production method of the present invention may include an adsorbent washing step. Specifically, the method of maintaining the aroma collecting apparatus may include an adsorbent washing step. In the production method of the present invention, minor fragments are not almost adsorbed by the adsorbent, but any other component contained in the gas (especially a polymerizable component) may be adsorbed by the adsorbent. An adsorbent washing method is well known to those skilled in the art, in which several kinds of solvents each having a different polarity that varies sequentially are introduced into the adsorbent. The kind of the solvent is not specifically limited. For example, an alcohol substance such as PG is applied to the adsorbent for desorption, and then ethyl acetate and hexane are introduced thereinto in that order for washing the adsorbent, and in regenerating the adsorbent, ethyl acetate and water may be introduced thereinto in that order.

Preferably, the adsorbent is reused until the operation of desorption and collection are repeated for a total of 5 times or more while, if desired, it is washed after collection of aroma compounds therefrom. More preferably, the adsorbent is reused until the operation is repeated for a total of 10 times.

### [Aroma Composition]

The aroma composition produced according to the production method for an aroma composition of the present invention contains aroma compounds that are emitted in fragmenting an animal or plant material, and gives an aroma perceivable in fragmenting the animal or plant material.

Specifically, the aroma that is emitted in fragmenting an animal or plant material is preferably an aroma perceivable in fragmenting the animal or plant material, for example, an aroma in grinding them, an aroma in fracturing them, an aroma in mincing them, an aroma in powdering them, or an aroma in flaking them.

### [Use of Aroma Composition Produced According to Production Method of the Invention]

The aroma composition produced according to the method for producing an aroma composition of the present invention can be added to various substrates such as foods and drinks, cosmetics, health and hygiene products and medicines to obtain flavored products.

Preferably, food and drink may contain, as added thereto, the aroma composition produced by the method for producing an aroma composition of the present invention in an amount of 0.01 to 10% by mass relative to the total mass of the food and drink, more preferably 0.05 to 7% by mass.

The food and drink is preferably a packed food or drink. The aroma composition produced according to the production method of the present invention has a strong top aroma (of a highly volatile component(s) having a low molecular weight). In addition, the aroma composition can give an aroma in the middle and later (of a relatively poorly volatile component(s)). Consequently, the packed food or drink that contains the aroma composition produced according to the production method of the present invention can give, when unpacked, a rich aroma that is emitted and perceivable in fragmenting an animal or plant material, and can also enhance the total flavor of food and drink.

Examples of the packed food and drink include frozen desserts such as ice cream, soft cream and sherbet; confectionery such as biscuit, cookie, rice cracker, steamed yeast bun with filling, chocolate, cream-filled confectionery, jelly, gum, candy and caramel; bread; soup stock from dried bonitos; seasonings such as dressing, spread and jam; flavor oils, frozen foods, and health foods (for example, Foods with Function Claims, dietary supplements, food for specified health use).

Packed drink means a drink having a suitable concentration for drinking and is packed in a container (generally, it is sterilized before and after packed in a container).

The packed drink is preferably a packed drink filled in a PET bottle, a can or a paper container. The packed drink includes tea-type drink such as barley tea drink, cereal tea drink, brown rice tea drink, and so-called mixed tea drink prepared by mixing tea and roasted cereal (blend tea drink); tea-type drink such as green tea drink, oolong tea drink, and red tea drink; coffee drink; and beer-taste drink such as beer, low-malt beer, so-called third beer (quasi-beer), nonalcoholic beer-taste drink.

The food and drink may be thermally sterilized. In production of packed drinks, the products are subjected to retort sterilization (thermal sterilization at 121° C. for 10 minutes or so) or UHT sterilization (thermal sterilization at 135° C. for 1 minute or so). However, ordinary aroma at the top is often lost by heating. The aroma composition produced according to the method for producing an aroma composition of the present invention has a strong aroma at the top and hardly loses the top aroma even when heated, and is therefore favorably used for food and drink to be thermally sterilized. In addition, consequently, the aroma composition of the present invention is also favorably used even in food and drink that are required to be heated before eating.

[Apparatus for Collecting Aroma from Animal or Plant Material]

The apparatus for collecting aroma from an animal or plant material of the present invention (hereinafter this may be referred to as the aroma collecting apparatus of the present invention) includes a device for fragmenting an animal or plant material,

a first flow channel which is communicated with the fragmenting device and through which a gas can flow, the gas containing aroma compounds that are emitted from the animal or plant material in fragmenting the animal and plant material and containing minor fragments,

a minor fragments removing device communicated with the first flow channel,

a second flow channel which is communicated with the minor fragments removing device and through which the gas, from which minor fragments have been removed, can flow,

an aroma compound adsorbing device communicated with the second flow channel, and

a gas flow generating device that generates a gas flow continuing from the fragmenting device to the aroma compound adsorbing device, and in which:

the aroma compound adsorbing device has an adsorbent holder that holds an adsorbent therein, and the adsorbent holder has a mesh lid at both ends thereof in the gas flowing direction therethrough.

Preferred embodiments of the aroma collecting apparatus of the present invention are described below.

### <Overall Structure of Aroma Collecting Apparatus>

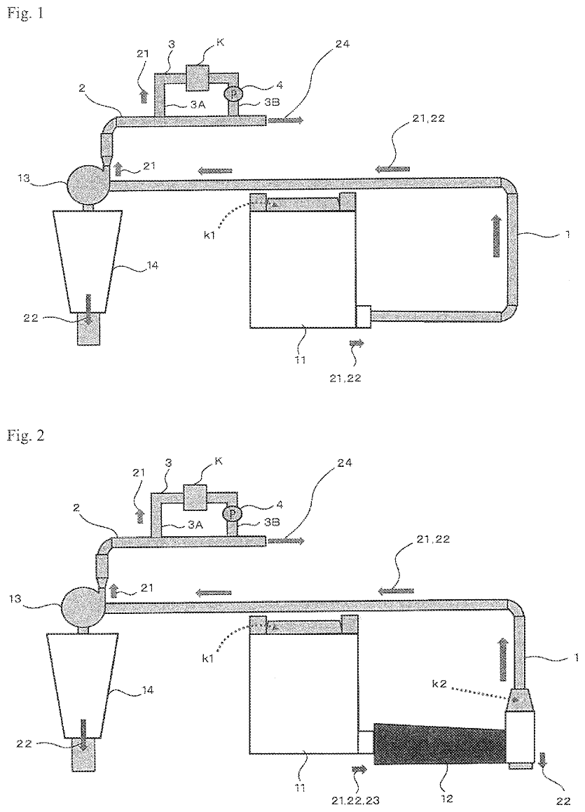

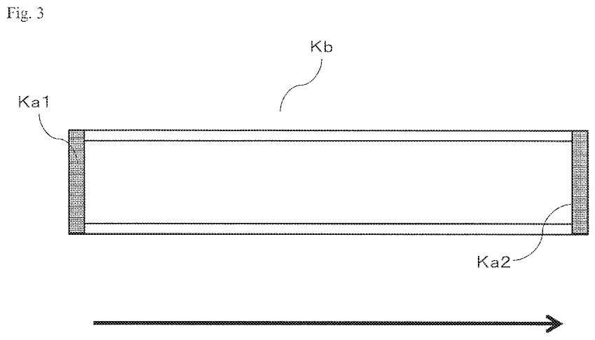

The overall structure of the aroma collecting apparatus is described with reference to the drawings attached hereto. FIG. 1 is a schematic view showing an example of an aroma collecting apparatus of the present invention. FIG. 2 is a schematic view showing another example of an aroma collecting apparatus of the present invention.

One example of the aroma collecting apparatus of FIG. 1 is provided with a fragmenting device 11, a first flow channel 1, a gas flow generating device 13, a minor fragments removing device 14, a second flow channel 2, and an aroma compound adsorbing device K. The aroma compound adsorbing device K has an adsorbent holder Kb having mesh lids Ka1 and Ka2 (FIG. 3). Further, one example of the aroma collecting apparatus of FIG. 1 is provided with a guide path 3 and a linear speed controlling device 4, but these are not indispensable components.

In the aroma collecting apparatus of FIG. 1, a fragmenting system having the fragmenting device 11, the first flow channel 1, the gas flow generating device 13, the minor fragments removing device 14 and the second flow channel 2 is generally used (for example, see U.S. Pat. No. 1,649,781 (1927)), and in the present invention, the aroma compound adsorbing device K is provided in such an ordinary fragmenting system so as to collect aroma compounds emitted from an animal or plant material in fragmenting the animal or plant material.

In the aroma collecting apparatus of FIG. 1, while an animal or plant material is fragmented in the fragmenting device 11 to give crude fragmented pieces of animal or plant materials, a gas that contains aroma compounds 21 emitted from the animal or plant material and minor fragments 22 contained in the crude fragmented pieces of animal or plant material is moved toward the first flow channel 1 from the fragmenting device 11 by the gas flow generated in the gas flow generating device 13. The gas that contains the aroma compounds and the minor fragments 22 moves with the gas flow from the first flow channel 1 to the minor fragments removing device 14. In the minor fragments removing device 14, the gas from which minor fragments have been removed (but which contains the aroma compounds 21) moves toward the second flow channel 2 while the minor fragments 22 are, after removed in the minor fragments removing device 14, discharged out of the apparatus. With the gas flow generated in the gas flow generating device 13 (optionally along with the gas flow generated in the linear speed controlling device 4), a part of the gas from which minor fragments have been removed (containing the aroma compounds 21) flows from the second flow channel 2 into the guide path 3, and then flows into the adsorbent held in the aroma compound adsorbing device K arranged in the guide path 3, that is, the gas is introduced into the adsorbent so that the aroma compounds 21 are adsorbed by the adsorbent. The gas from which the aroma compounds 21 has been adsorbed by the adsorbent and which has flowed through the adsorbent is again moved to the second flow channel 2 through the outlet port 3B of the guide path, and is combined with the gas which did not flow into the guide path 3 but flowed through the second flow channel 2 and from which the minor fragments were removed, and is discharged out of the apparatus as an exhaust gas 24.

In the present invention the guide path 3 is not an indispensable component as so mentioned hereinabove, and therefore, without providing the guide path 3, not a part but all of the gas flowing through the second flow channel (containing the aroma compounds 21 but not containing the minor fragments) may be introduced into the aroma compound adsorbing device K. In this case, the aroma compound adsorbing device K may be arranged in the second flow channel.

Another example of the aroma collecting apparatus of FIG. 2 is provided with a fragmenting device 11, a minor fragments preremoving device 12, a first flow channel 1, a gas flow generating device 13, a minor fragments removing device 14, a second flow channel 2, and an aroma compound adsorbing device K. The example of the aroma collecting apparatus of FIG. 2 is provided with a guide path 3 and a linear speed controlling device 4, but these are not indispensable components.

In the aroma collecting apparatus of FIG. 2, crude fragmented pieces of the animal or plant material produced by fragmenting the animal or plant material in the fragmenting device 11 are transferred to the minor fragments preremoving device 12 by a transport system not shown. In the minor fragments preremoving device 12, at least a part of the minor fragments 22 are removed from the crude fragmented pieces of the animal or plant material, and the removed minor fragments 22 are housed in a waste chamber not shown and are thus discharged out of the system. On the other hand, the gas containing the aroma compounds 21 and containing the minor fragments 22 not removed in the minor fragments preremoving device 12 moves toward the first flow channel 1 along with the gas flow generated in the gas flow generating device 13. The flow of the aroma compounds 21 and the minor fragments 22 after the first flow channel 1 is the same as in FIG. 1.

Preferred embodiments of the devices which the aroma collecting apparatus preferably includes are described hereinunder.

### <Fragmenting Device>

The aroma collecting apparatus of the present invention is provided with a fragmenting device for an animal or plant material.

The fragmenting device is not specifically limited. For example, a roller mill, a powdering machine or a flaking machine may be used.

The gas to be generated by fragmenting in the fragmenting device 11 is transported to the adsorbent along with the gas flow generated in the gas flow generating device and is therefore hardly spread out, and consequently, the fragmenting device is not necessarily required to be closed up. However, from the viewpoint of efficiently collecting the aroma compounds, the fragmenting device 11 may be communicated with the first flow channel 1 and the other parts may be closed up during fragmenting operation.

### <Minor Fragments Preremoving Device>

Preferably, the aroma collecting apparatus of the present invention is further provided with a minor fragments preremoving device between the fragmenting device and the first flow channel.

Preferably, the minor fragments preremoving device is communicated with the fragmenting device to remove at least a part of the minor fragments from the crude fragmented pieces of the animal or plant material obtained by fragmenting the animal or plant material. The pure fragmented pieces of the animal or plant material from which minor fragments have been removed (that is, fragmented pieces of animal or plant material themselves fragmented to have a desired size) can be used as a food or drink or for production thereof.

A part of most of the minor fragments may be removed and discharged out of the system. When the amount of the minor fragments that move to the first flow channel from the minor fragments preremoving device is smaller, the load to the downstream, i.e., the minor fragments removing device, can be reduced more.

Any known device is usable as the minor fragments preremoving device, and a classification device such as a shaking sieve or a wind-driven classifier is preferably used.

### <First Flow Channel>

The aroma collecting apparatus of the present invention is provided with a first flow channel which is communicated with the fragmenting device and through which the gas can flow, wherein the gas contains the aroma compounds that are emitted from the animal or plant material and contains the minor fragments.

The first flow channel may be directly communicated with the fragmenting device, or may be communicated with the fragmenting device via the minor fragments preremoving device.

Though not specifically limited, the diameter (inner diameter) of the first flow channel is, from the viewpoint of making more gas flow therethrough, preferably 30 mm or more, more preferably 50 mm or more, even more preferably 100 mm or more, further more preferably 200 mm or more, and especially more preferably 300 mm or more.

The minor fragments preremoving device 12 may be provided with a suction mouth to be coupled with the first flow channel 1.

### <Minor Fragments Removing Device>

The aroma collecting apparatus of the present invention is provided with a minor fragments removing device communicated with the first flow channel to remove minor fragments.

Any known device may be used as the minor fragments removing device, and a cyclone-type separating device (powder separating device) is preferably used.

### <Second Flow Channel>

The aroma collecting apparatus of the present invention is provided with a second flow channel communicated with the minor fragments removing device, through which the gas from which minor fragments have been removed can flow.

In the aroma collecting apparatus of the present invention, the diameter (inner diameter) of the second flow channel is not specifically limited and is preferably 30 mm or more from the viewpoint of making more gas flow therethrough, more preferably 50 mm or more, even more preferably 100 mm or more, further more preferably 200 mm or more, and especially preferably 300 mm or more. The second flow channel can be arranged in any desired manner so that the direction of the gas to flow into the aroma compound adsorbing device to be mentioned below can be a desired direction.

### <Aroma Compound Adsorbing Device>

The aroma collecting apparatus of the present invention is provided with an aroma compound adsorbing device communicated with the second flow channel.

The aroma compound adsorbing device has an adsorbent holder that holds an adsorbent therein, and the adsorbent holder has a mesh lid at both ends thereof in the gas flowing direction therethrough. The mesh lid prevents the adsorbent held in the adsorbent holder from leaking out of the aroma compound adsorbing device to enable the gas to flow through the adsorbent.

The mesh lid is a sheet having a desired thickness, and, not specifically limited thereto, the size thereof can be selected to fall within a range capable of preventing the adsorbent from leaking out of the aroma compound adsorbing device. From the viewpoint of securing easy gas flowing therethrough, the mesh lid preferably has an area not smaller than the cross section in the gas flowing direction of the adsorbent holder.

The mesh lid may have a mesh structure wholly or partly. From the viewpoint of securing easy gas flowing therethrough, preferably, a part of the mesh lid corresponding to the cross section of the aroma compound adsorbing device or the adsorbent holder has a mesh structure.

The opening of the mesh lid may be selected in any desired manner within a range within which the adsorbent used may not pass therethrough. Not limited thereto, an example of the opening is within a range of 10 μm to 20 mm.

In the present invention, preferably, the aroma compound adsorbing device includes a part occupied by the adsorbent held in the adsorbent holder therein, that is, the adsorbent part.

In the present invention, the length of the adsorbent part (in the gas flowing direction) is, though not specifically limited thereto but from the viewpoint of reducing the adsorbent resistance, preferably 1000 mm or less, more preferably 700 mm or less, even more preferably 500 mm or less, further more preferably 400 mm or less, even further more preferably 300 mm or less, and especially more preferably 200 mm or less. For example, the length of the adsorbent part may fall within a range of 10 mm to 800 mm, 20 mm to 400 mm, 40 mm to 200 mm, or 50 mm to 100 mm.

The long axis or the diameter of the plane vertical to the gas flowing direction in the adsorbent part (hereinafter they are referred to as a cross-section diameter) is, though not specifically limited, preferably controlled in accordance with the amount of the adsorbent and the length of the adsorbent part. The cross-section diameter of the adsorbent part is, from the viewpoint of securing easy gas flowing, preferably 10 mm or more, more preferably 30 mm or more, even more preferably 50 mm or more, further more preferably 100 mm or more, even further more preferably 200 mm or more, and especially more preferably 300 mm or more.

In the case where the adsorbent amount is desired to be increased, preferably, the cross-section diameter of the adsorbent part is increased and the length of the adsorbent part (in the gas flowing direction) is reduced from the viewpoint of reducing the adsorbent resistance to the gas flowing therethrough.

The adsorbent amount is not limited so far as it can be held in the adsorbent holder. The bulk volume of the adsorbent to be used may be the same as or less than the volume of the adsorbent holder. In other words, the adsorbent may be filled (roughly filled or densely filled) in the adsorbent holder, or the adsorbent holder holding the adsorbent therein may have some void space.

Regarding the arrangement of the aroma compound adsorbing device, the aroma compound adsorbing device is arranged parallel to the installation surface of the aroma collecting apparatus (parallel to the ground contact surface, that is, horizontally) in FIGS. 1 and 2, but the device may also be arranged vertical to the installation surface, or at any other angle thereto. Also, the device may be so arranged that the gas direction flowing into or through the adsorbent can come close to the installation surface of the aroma collecting apparatus, or can go away from the installation surface thereof. In other words, the aroma compound adsorbing device and the gas direction flowing into or through the adsorbent can be substantially opposite to or substantially the same as the direction of gravitational force, or can also be perpendicular thereto, or may be at any other angle.

In the case where the aroma compound adsorbing device is a fluidized-bed column, the column may be so arranged that the bulk volume of the adsorbent to be used is lower than the volume of the adsorbent holder and the gas direction flowing into or through the adsorbent is substantially opposite to the direction of gravitational force. Using a fluidized-bed column can reduce the adsorbent resistance to the gas flowing therethrough.

The aroma compound adsorbing device may be provided with a basket as the adsorbent holder therein. As the basket, there are known a normal-type basket having pores through the side surface thereof, and a sidewall-type basket not having pores through the side surface thereof. Using a sidewall-type basket not having pores through the side surface thereof is preferred from the viewpoint that the gas from which minor fragments have been removed would not leak through the side surface of the basket and therefore the length of the gas flow through the adsorbent can be increased.

### <Gas Flow Generating Device>

The aroma collecting apparatus of the present invention is provided with a gas flow generating device capable of generating a gas flow continuing from the fragmenting device to the aroma compound adsorbing device. The gas flow generating device 13 can generate a gas flow that continues through the fragmenting device 11, (the minor fragments preremoving device 12), the first flow channel 1, the minor fragments removing device 14, the second flow channel 2 and the aroma compound adsorbing device K.

The gas flow generating device may be a blower or a suction aspirator. Examples of a suction aspirator include a suction blower.

### <Guide Path>

Preferably, the aroma collecting apparatus is provided with a guide path 3 in the flow channel of the gas from which minor fragments have been removed (the second flow channel), as branched from this flow channel and communicated with the aroma compound adsorbing device, from the viewpoint that only a part of the gas from which minor fragments have been removed can flow into the guide path and the adsorbent to collect aroma compounds while suppressing the adsorbent resistance. In that manner, the aroma compound adsorbing device may be communicated with the second flow channel via the guide path.

The diameter (inner diameter) of the guide path is, though not specifically limited, preferably 5 mm or more as the inner diameter from the viewpoint of more gas can flow through the guide path, more preferably 15 mm or more, even more preferably 30 mm or more, further more preferably 50 mm or more, even further more preferably 70 mm or more, still further more preferably 100 m or more, still further more preferably 150 mm or more, still further more preferably 200 mm or more, and especially more preferably 300 mm or more.

The guide path 3 may be formed integrally with the second flow channel, or may be detachably connected to the second flow channel. At least a part of the guide path 3 may be fixed to the second flow channel 2 by means of any desired fixing means such as an adhesive tape or screws.

The inlet port 3A of the guide path 3 may be branched at any position of the second flow channel 2. For example, in FIG. 1, the port is arranged at the position extending horizontally (in the right and left direction on the paper) from the second flow channel 2, but may also be arranged in the second flow channel 2 extending in the vertical direction (in the upper direction on the paper) from the gas flow generating device 13.

Preferably, the outlet port 3B of the guide path 3 is connected to the second flow channel 2 so that the gas can be returned back to the second flow channel 2 after the adsorption of the aroma compounds.

The inlet port 3A and the outlet port 3B of the guide path 3 each may be connected to the second flow channel 2 at any angle, and the guide path 3 may be linear, or curved, or may be folded at one or more position.

The material of the guide path 3 is not specifically limited, and may be made of, for example, a metal or a resin.

### <Linear Speed Controlling Device>

Preferably, the aroma collecting apparatus of the present invention is further provided with a linear speed controlling device 4 for controlling the linear speed of the gas from which minor fragments have been removed.

The linear speed controlling device may be a blower or a suction aspirator. Examples thereof include a blower fan and a suction pump.

The position of the linear speed controlling device in the aroma collecting apparatus of the present invention is not specifically limited, and depending on the type thereof, the device may be arranged either upstream or downstream of the flow of the gas flowing through the aroma compound adsorbing device. For example, a blower may be arranged at the upstream, and a suction aspirator may be arranged at the downstream.

The suction aspirator to be used as the linear speed controlling device 4 is preferably one having a higher pumping performance than that of the gas flow generating device 13 from the viewpoint of efficiently collecting aroma compounds.

Preferably, the linear speed controlling device 4 is arranged in the guide path 3. The linear speed controlling device 4 may be arranged at the inlet port 3A of the guide path, or at the outlet port 3B of the guide path.

### EXAMPLES

The present invention is described more specifically with reference to the following Examples and Comparative Examples. In the following Examples, the material used, its amount and ratio, the details of the treatment and the treatment process may be suitably modified or changed not overstepping the spirit and the scope of the invention. Accordingly, the invention should not be limitatively interpreted by the Examples mentioned below.

### Example 1

In the present invention using an exhaust gas flow from a fragmenting device, a pressure is given to the inlet port of an aroma compound adsorbing device since an adsorbent is used therein, and consequently, it is desirable whether or not the constitution may impart any load on the gas flow generating device employed in the aroma collecting apparatus of the present invention.

Accordingly in Example 1, an gas flow is introduced into the aroma compound adsorbing device K while the cross-section diameter and the length of the adsorbent part of the aroma compound adsorbing device K, which the aroma collecting apparatus A of the present invention has, are appropriately changed to thereby confirm the presence or absence of a suitable range of the diameter and the length. The aroma compound adsorbing device has mesh lids Ka1 and Ka2, and an adsorbent holder Kb (FIG. 3).

As the adsorbent to be held in the aroma compound adsorbing device K, SP-207 (styrene-divinylbenzene copolymer synthetic adsorbent, manufactured by Mitsubishi Chemical Corporation) was used. As the adsorbent holder to hold the adsorbent (in a roughly filled manner), a cylindrical sidewall-type basket not having pores through the side surface was used.

Next, aromatic compound adsorbing devices, in which the cross-section diameter and the length of the adsorbent part as occupied by the adsorbent held in the aroma compound adsorbing device K were changed as in the following Table 1, were prepared, and for each device, the suction pump arranged at the end of the aroma compound adsorbing device K was driven for gas flowing through the adsorbent held in the aroma compound adsorbing device K. With that, the pressure at the inlet port of each aroma compound adsorbing device and the air flow at the outlet port thereof were measured. In this Example, the cross-section diameter of the adsorbent part is the same as the cross-section diameter (inner diameter) in the air flowing direction of the above-mentioned basket. The aroma compound adsorbing device K was arranged substantially vertically to the ground surface, and the air flowing direction through the adsorbent was substantially the same as the direction of gravitational force.

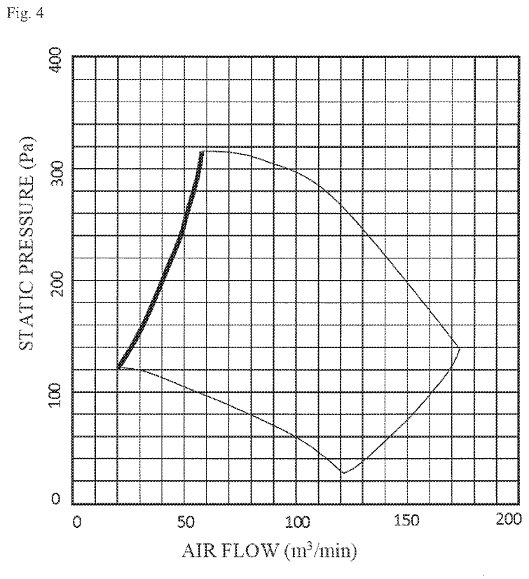

Next, as to whether or not the performance curve (also referred to as airflow-static pressure characteristic curve) of the device would overstep a range of the performance curve of an ordinary blower (gas flow generating device) was confirmed through calculation. This curve is drawn by plotting the relationship between the gas flow pressure and the air volume generated by a blower when the blower motor output is 1.5 to 10 kW. In the case where the performance curve of the tested device does not overstep the range of the performance curve shown in FIG. 4, it suggests that the blower performance is higher than the resistance of the adsorbent within the above-mentioned motor output range and therefore the gas flow generated by the blower can flow through the adsorbent. On the other hand, in the case where the performance curve of the tested blower oversteps toward the left side than the thick line of the curve, it suggests that the output gas amount is still unsatisfactory even under a high pressure, that is, the adsorbent resistance is higher than the blower performance so that a load is given on the blower by the adsorbent.

The results are shown in the following Table 1.

TABLE 1

| | Cross-Section Diameter (mm) of | | | | | | | |
|---|---|---|---|---|---|---|---|---|
| | Adsorbent Part | | | | | | | |
| | 20 | 40 | 60 | 80 | 100 | 150 | 200 | 300 |
| Length (cm) of Adsorbent Part | 75 | 37.5 | 25 | 18.7 | 15 | 10 | 7.5 | 5 |
| (gas-flowing direction) | | | | | | | | |

| | | |
|---|---|---|
| Deviation from Performance | Deviated toward | Fell within the range. |
| Curve | the left. | |

The above Table 1 confirms that, owing to the adsorbent resistance to the gas flow, the length of the adsorbent part (in the gas flowing direction) is preferably not more than a predetermined level.

In collecting aroma compounds, it is confirmed that the method preferably includes a step of optimizing the length of the adsorbent part (in the gas flowing direction) depending on the performance of the gas flow generating device employed in the aroma collecting apparatus of the present invention. In addition, it is also confirmed that, in the case where the adsorbent amount is desired to be increased, the cross-section diameter of the adsorbent part is preferably increased without increasing the length of the adsorbent part to thereby reduce the length of the adsorbent part (in the gas flowing direction).

As obvious from the test results, in the case where the performance curve of a system that employs an adsorbent part having a certain length deviates toward the left side from the performance curve of the gas flow generating device that is intended to be used, a linear speed controlling device 4 such as a blower or a suction pump may be additionally arranged near the aroma compound adsorbing device K to generate a gas flow with which the pressure of the gas flow generated by the gas flow generating device 13 can be subsidiary increased, thereby introducing a sufficient gas into the adsorbent.

In addition, it is obvious that, by using a means of reducing the pressure by the adsorbent, for example, by using an adsorbing device where the adsorbent to be held therein is movable, such as a fluidized-bed column, as the aroma compound adsorbing device, or by using any other means of making the gas flow generated by the gas flow generating device 13 partly branch and making the thus-branched gas flow introduced into the adsorbent, sufficient gas flow introduction to the adsorbent is realized only by an ordinary blower even in the absence of the linear speed controlling device 4.

As described above, in the present invention, by appropriately controlling the length of the gas flowing direction through the adsorbent part or by generating a branched or unbranched gas flow or by appropriately controlling the mobility of the adsorbent, in accordance with the gas flow generating device for an ordinary fragmenting device generally used in the art, a load on an ordinary fragmenting device can be suppressed more.

### Example 2

Collection of aroma compounds in fragmenting roasted sesame, sensory evaluation of aroma compositions, and load on aroma collecting apparatuses were investigated.

### (1) Aroma Collection

First, an outline of an aroma collecting apparatus A for use in the present Example is shown.

The aroma collecting apparatus A of the present invention has a configuration as shown in FIG. 1. Specifically, the aroma collecting apparatus A of the present invention is provided with a fragmenting device 11, a first flow channel 1, a gas flow generating device 13, a minor fragments removing device 14, a second flow channel 2, and an aroma compound adsorbing device K. In FIG. 1, the aroma compound adsorbing device K is illustrated to be parallel to the installation surface of the aroma collecting apparatus A (parallel to the ground contact surface, that is, horizontally), but herein, the aroma compound adsorbing device K was arranged substantially vertically to the installation surface and the gas flowing direction in the adsorbent part was made substantially the same as the direction of gravitational force.

The aroma collecting apparatus A is provided with a roller mill as the fragmenting device 11. The fragmenting device 11 is communicated with the minor fragments preremoving device 12, and the other parts can be kept closed during fragmenting.

The first flow channel 1 is communicated with the fragmenting device 11. The gas flow generating device 13 is communicated with the first flow channel 1 and the second flow channel 2.

The aroma collecting apparatus A is provided with a suction blower as the gas flow generating device 13. The suction blower can generate a gas flow that continues through the fragmenting device 11, the first flow channel 1, the minor fragments removing device 14, the second flow channel 2 and the aroma compound adsorbing device K. In addition, the apparatus is provided with a suction pump as the linear speed controlling device 4 downstream the gas flow after the aroma compound adsorbing device K to generate a gas flow along with the gas flow generating device 13.

The aroma collecting apparatus A is provided with a cyclone-type separating device as the minor fragments removing device 14.

The first flow channel 1 and the second flow channel 2 each have an inner diameter of 200 mm.

The aroma collecting apparatus A is provided with the aroma compound adsorbing device K in the guide path 3 branched from the second flow channel 2 having an inner diameter of 200 mm. The guide path 3 is so planned that a half of the gas flowing into the second flow channel before the inlet port 3A of the guide path could flow thereinto. The entire amount of the gas having flowed into the guide path 3 flows into the aroma compound adsorbing device K.

As Comparative Example 1, an aroma collecting apparatus a1 was prepared in the same manner as the aroma collecting apparatus A was prepared, except that this apparatus is provided with an aroma compound adsorbing device k1 branching from the top of the fragmenting device 11, in place of the aroma compound adsorbing device K. The aroma compound adsorbing device k1 is so planned as to have a guide path that guides a gas flow into an adsorbent as branched from the top of the fragmenting device 11, and an exhaust path to discharge the gas flow having gone out from the adsorbent. The amount of the gas flowing in the guide path branched from the top of the fragmenting device 11 is so planned as to be the same amount of the gas flowing into the guide path 3 of the aroma collecting apparatus A.

Further, as Comparative Example 2, an aroma collecting apparatus a2 was prepared in the same manner as the aroma collecting apparatus A was prepared, except that this apparatus is provided with an aroma compound adsorbing device k2 branching from the middle of the first flow channel 1, in place of the aroma compound adsorbing device K. The aroma compound adsorbing device k2 is so planned as to have a guide path that guides a gas flow into an adsorbent as branched from the first flow channel 1 having an inner diameter of 200 mm, and an exhaust path to discharge the gas flow having gone out from the adsorbent. The amount of the gas flowing in the guide path is so planned that a half of the gas flowing through the first flow channel 1 before the inlet port thereof (that is, the same amount as that of the gas flowing into the guide path 3 of the aroma collecting apparatus A) can flow therethrough.

The aroma compound adsorbing device K, the aroma compound adsorbing device k1 and the aroma compound adsorbing k2 all are filled with the same amount of the same adsorbent.

Using the aroma collecting apparatus A of the present invention, the aroma collecting apparatus a1 of Comparative Example 1, and the aroma collecting apparatus a2 of Comparative Example 2, aroma compounds from fragmenting roasted sesame were collected.

Specifically, aroma compounds were collected according to the following method.

While a gas flow was kept generated in the gas flow generating device 13, roasted sesame was fragmented at 100 kg/h using a roller mill (fragmenting device 11) to have a fragmented size of about 1 mm, thereby giving a crude fragmented pieces of roasted sesame (crude fragmented pieces of an animal and plant material 23) containing minor fragments.

At least a part of minor fragments 22 contained in the crude fragmented pieces of roasted sesame (crude fragmented pieces of animal and plant material 23) were made to flow through the first flow channel 1 communicated with the fragmenting device 11, along with the gas (the gas containing aroma compounds 21) inside the fragmenting device 11 being grinding the roasted sesame and by the gas flow generated as above.

The minor fragments 22 were remove from the gas containing the aroma compounds 21 emitted from the roasted sesame in fragmenting the roasted sesame, and containing the minor fragments 22, in the minor fragments removing device 14.

The minor fragments 22 removed from the gas was stored in a waste chamber (not shown) communicated with the minor fragments removing device 14, and then discarded.

On the other hand, the gas from which minor fragments 22 had been removed was made to flow through the second flow channel 2 communicated with the minor fragments removing device 14. The linear speed of the gas flowing through the second flow channel was 4.1 m/s. A half of the gas flowing through the second flow channel 2 flowed into the guide path 3, as so mentioned hereinabove.

During grinding the roasted sesame, the gas having flowed into the guide path 3 was then made to flow through the adsorbent held (roughly filled) in the adsorbent holder Kb in the aroma compound adsorbing device (K, k1 or k2), whereby the aroma compounds 21 contained in the gas was adsorbed by the adsorbent.

In all the aroma compound adsorbing devices, the adsorbent and the gas flowing condition were the same, as follows. As the adsorbent holder, a cylindrical sidewall-type basket not having pores through the side was used. For preventing it from cracking, the adsorbent was made to previously absorb pure water, and then filled in the aroma compound adsorbing device before completely dried.

Aroma compound adsorbent: SP-207 (synthetic adsorbent of styrene-divinylbenzene copolymer, manufactured by Mitsubishi Chemical Corporation)

Cross-section diameter of adsorbent part: 100 mm

Linear speed of gas flowing into adsorbent: 2.0 m/s

Length (length in the gas flowing direction) of adsorbent part: 8.0 cm

Amount of adsorbent: 2500 ml

Type of gas: air

Time of grinding and gas flow introduction into adsorbent part: 5 hours

In this Example, the cross-section diameter of the adsorbent part is the same as the cross-section diameter (inner diameter) in the gas flowing direction of the above-mentioned basket.

After the gas flow introduction for 5 hours through each aroma collecting apparatus, 25 kg of propylene glycol (PG) was introduced into the adsorbent in each aroma compound adsorbing device at SV=10 so as to desorb the aroma compounds 21 from the adsorbent. SV (space velocity) means a unit of the volume of the desorbent to be introduced relative to the volume of the resin per hour. The process gave a roasted sesame flavor (an aroma composition as a PG solution) containing the aroma compounds having collected in the aroma compound adsorbing device K, k1 or k2. The resultant aroma compositions were referred to as an invention product 1, a comparative product 1 and a comparative product 2.

Here, a half of the gas containing the aroma compound emitted from 500 kg (grinding for 5 hours at 100 kg/hr) of the roasted sesame that had been ground (fragmented) was introduced into the adsorbent (as described above, the apparatus was so planned that a half of the gas flowing through the second flow channel 2 could be introduced into the guide path 3 to run through the adsorbent), and therefore, the adsorbent adsorbed a gas containing the aroma compounds from 250 kg of the ground, roasted sesame, and that amount of the aroma compounds was desorbed with PG to give a 25 kg of a PG solution (aroma composition) so that the weight of the aroma composition could be 10% of the weight of the roasted sesame that emitted the aroma compounds, and according to the process, the invention product 1, and the comparative products 1 and 2 were prepared.

On the other hand, the aroma compounds of the crude fragmented pieces of roasted sesame were collected through steam distillation to prepare the comparative compound 1. Specifically, 2000 g of the ground roasted sesame were put into a 3-liter column, then steam was jetted thereinto from the bottom of the column under atmospheric pressure for 2 hours for steam distillation, and the steam containing the aroma compound(s) coming out from the top of the column was condensed through a condenser tube to give 2000 g of an aqueous solution containing the aroma compounds. Next, the resultant aqueous solution was introduced into 50 ml of an adsorbent (SP-207), then 200 g of PG was introduced into the adsorbent to desorb the adsorbed aroma compounds, thereby giving 200 g of a PG solution as a steam-distillation flavoring composition. The steam-distillation flavoring composition is referred to as a comparative product 3. Also here, like the invention product 1 and the comparative products 1 and 2, the comparative product 3 was made to have a mass ratio of 10% so as to be directly compared with the invention product 1 and the comparative products 1 and 2 in point of aroma.

### (2) Load on Aroma Collecting Apparatus

After collecting the aroma compounds, the adsorbent from which the aroma compounds had been desorbed was checked for the reusability thereof.

The reusability was confirmed by comparing the pressures of the liquid flowing through the adsorbents (hereinafter each referred to as the adsorbent q1, the adsorbent q2 and the adsorbent Q) held in the aroma compound adsorbing devices (k1, k2 and K, respectively), before and after desorption with PG. Specifically, before and after desorption, the adsorbent holder was purged with ultrapure water and then ultrapure water was introduced into the adsorbent at SV=10, and a ratio of the pressure after desorption to the pressure before desorption was calculated.

As a result, the pressure ratios through the adsorbent q1 and the adsorbent q2 were 10 times and 5 times, respectively, which indicates clogging of the adsorbents. In such a case, these adsorbents must be washed a few times or must be discarded. On the other hand, there was seen little pressure difference in the case of the adsorbent Q, which indicates that no clogging has occurred and it is unnecessary to wash or discard the adsorbent.

The above confirms that the aroma collecting apparatus of the present invention saves time and work for adsorbent regeneration and saves cost thereof. In addition, it is confirmed that the apparatuses of Comparative Examples are unsuitable for industrial use for aroma collection from roasted sesame in grinding roasted sesame.

### (3) Sensory Evaluation of Composition

Each of the compositions of the invention product 1 and the comparative products 1 to 3 was added to a commercially-prepared sesame oil in an amount shown in Table 2 below, thereby preparing flavored sesame oil products. As compared with the commercially-prepared sesame oil (unflavored), the flavored sesame oils were subjected to a sensory evaluation by well-trained 10 panelists in point of the flavor thereof. Average sensory evaluation results of the 10 panelists are shown in Table 2 below.

TABLE 2

| Type of Added Composition | Amount of Composition | |
|---|---|---|
| (type of aroma compound | Added (relative to | |
| adsorbing device or steam | the total amount of | |
| distillation) | flavored sesame oil) | Average Evaluation |
| Comparative Product 1 (k1) | 0.2 mass % | The aroma of roasted sesame is somewhat enhanced, |
| | | but the aroma is weak and is poorly sustainable. |
| Comparative Product 2 (k2) | 0.2 mass % | The aroma of roasted sesame is somewhat enhanced, |
| | | but the aroma is weak and is poorly sustainable. |
| Comparative Product 3 | 0.2 mass % | The aroma of roasted sesame is somewhat enhanced, |
| (steam distillation) | | but the top aroma is weak, and the product gives |
| | | some unfavorable heavy feeling. |
| Invention Product 1 (K) | 0.2 mass % | A fresh and roasty aroma perceivable in grinding |
| | | roasted sesame is given strongly at the top, and |
| | | the product gives some favorable light feeling |
| | | for long. |
| Comparative Product 3 and | 0.2 mass % | Freshness and lightness perceivable in grinding |
| Invention Product 1 | (0.1 mass % of | roasted sesame, as well as richness is enhanced, |
| | comparative product | and the product gives a well-balanced and |
| | 3 and 0.1 mass % of | sustainable aroma. |
| | invention product) | |

As shown in Table 2, the aroma composition of the invention product 1 is a flavoring composition that gives a strong fresh and roasty aroma perceivable in grinding roasted sesame, and is excellent in sustainability of the aroma.

Further, it is confirmed that, when combined with any other flavoring composition such as a flavoring composition obtained in steam distillation, the aroma composition of the invention product 1 can enhance the top aroma and can improve the flavor balance, the sustainability and the aroma intensity. This is considered to be because, as confirmed in (2), the adsorbents in the comparative cases were clogged by minor fragments and owing to it, the aroma compound adsorption efficiency thereof was worsened to make differences in the aroma characteristics and the aroma intensity.

### Example 3

Aroma compounds emitted in fragmenting peanuts were collected and a sensory evaluation was conducted.

In the same manner as in Example 2 except that the size in fragmentation was changed to 2 mm, aroma compounds were collected from the aroma compound adsorbing device 1 (arranged at the top of the fragmenting device 11), the aroma compound adsorbing device k2 (arranged in the first flow channel 1) and the aroma compound adsorbing device K (arranged in the second flow channel 2), while the minor fragments 22 derived from peanut bodies, peanut hulls and other foreign substances were removed from the gas.

Also in the same manner as in Example 2, aroma compound-containing peanut flavoring compositions (aroma compositions each as a PG solution) were obtained to be a comparative product 4, a comparative product 5 and an invention product 2 (containing the aroma compounds collected from the aroma compound adsorbing device K).

Also in the same manner as in Example 2, a steam-distillation flavoring composition of peanuts was prepared to be a comparative product 6.

Next, according to the formulation of Table 3 below, peanut-like flavored caramels containing any of the invention product 2 and the comparative products 4 to 6 were prepared.

TABLE 3

| | Amount |
|---|---|
| Ingredients | (part by mass) |
| Starch Syrup (75 mass % solid content) | 325 |
| Whole-milk Sugared Condensed Milk | 325 |
| Oils and Fats (shortening) | 80 |
| Homogen NO. 994(emulsifier) | 3 |
| Sugar | 260 |
| Soft Flour | 20 |
| Comparative Product 4, 5, 6 or Invention Product 2 | 1 |
| Water | 500 |
| Finished Dough after Concentration | about 1000 |

The resultant peanut-like flavored caramels were subjected to a sensory evaluation by well-trained 10 panelists in point of the flavor thereof. Average sensory evaluation results of the 10 panelists are shown in Table 4 below.

TABLE 4

| Type of Added Composition | |
|---|---|
| (type of aroma compound | |
| adsorbing device or steam | |
| distillation) | Average Evaluation |
| Comparative Product 4 (k1) | Though recognized, the peanut aroma is |
| | weak and is poorly sustainable. |
| Comparative Product 5 (k2) | Though recognized, the peanut aroma is |
| | weak and is poorly sustainable. |
| Comparative Product 6 | A heavy peanut-like aroma is given and |
| (steam distillation) | is somewhat unpleasant. |
| Invention Product 2 (K) | Like that given in roasting peanuts, a |
| | fresh, roasty and rich peanut-like aroma |
| | is given at the top, and is sustainable. |

As shown in the above Table 4, the aroma composition of the invention product 2 is a flavoring composition excellent in a fresh, rich and roasty aroma like that in roasting peanuts.

The aroma composition of the invention product 2 contains a large amount of aroma compounds at the top and can impart a good flavor even to food and drink like caramel that requires a heating step in the production process thereof, without losing the top aroma thereof.

### Example 4

Aroma compounds emitted in fragmenting dried bonitos were collected and a sensory evaluation was conducted.

In the same manner as in Example 3, aroma compounds were collected from the aroma compound adsorbing device 1 (arranged at the top of the fragmenting device 11), the aroma compound adsorbing device k2 (arranged in the first flow channel 1) and the aroma compound adsorbing device K (arranged in the second flow channel 2), while the minor fragments 22 formed in fragmenting dried bonitos were removed from the gas.

In the same manner as in Example 2, aroma compound-containing dried bonito aroma compositions (aroma compositions each as a PG solution) were obtained to be a comparative product 7, a comparative product 8 and an invention product 3 (containing the aroma compounds collected from the aroma compound adsorbing device K).

Also in the same manner as in Example 2, a steam-distillation flavoring composition of dried bonitos was prepared to be a comparative product 9.

Next, 1 g of commercially-prepared, granular soup broth of dried bonito was dissolved in 150 g of hot water at about 65° C. to prepare a soup broth, to which the comparative products 7, 8 or 9 or the invention product 3 was added to have a concentration of 0.1% by mass, thereby preparing a flavored soup broth.

As compared with the commercially-prepared, unflavored soup broth of dried bonito, the flavored soup broths were subjected to a sensory evaluation by well-trained 15 panelists in point of the flavor thereof. Average sensory evaluation results of the 15 panelists are shown in Table 2 below.

TABLE 5

| Type of Added Composition | |
|---|---|
| (type of aroma compound | |
| adsorbing device or steam | |
| distillation) | Average Evaluation |
| Comparative Product 7 (k1) | Though somewhat enhanced, the dried |
| | bonito aroma is weak and is poorly |
| | sustainable. |
| Comparative Product 8 (k2) | Though somewhat enhanced, the dried |
| | bonito aroma at the top is weak and |
| | is poorly balanced. |
| Comparative Product 9 | Though enhanced, the dried bonito |
| (steam distillation) | aroma is weak and is poorly |
| | sustainable. |
| Invention Product 3 (K) | Not given by unflavored soup stock, |
| | a fresh and full-bodied, dried bonito |
| | flakes-like flavor like that given in |
| | flaking dried bonito is strongly given |
| | at the top, and is sustainable and well |
| | balanced. |

As shown in the above Table 5, it is confirmed that the aroma composition of the invention product 3 is, differing from the comparative products, able to provide an aroma to be given in flaking dried bonito, and the aroma thereof at the top is strong and is sustainable.

### Example 5

Aroma compounds emitted in fragmenting roasted cacao nuts were collected and a sensory evaluation was conducted.

Aroma compounds emitted in fragmenting roasted cacao nuts were collected according to the following method. Roasted cacao nuts have, as adhering thereto, thin skins called husks.

In Example 5, used was an aroma collecting apparatus B (see FIG. 2) further equipped with a minor fragments preremoving device 12 communicated with the fragmenting device 11, in place of the aroma collecting apparatus A used in Examples 2 to 4. As the minor fragments preremoving device 12, a shaking classifier equipped with a sieve (opening 1.7 mm) was used, and the first flow channel 1 is communicated with the minor fragments preremoving device 12 and the gas flow generating device 13.

Like in Comparative Example 1, herein prepared was the aroma collecting apparatus b1 as Comparative Example 3, which is the same as the aroma collecting apparatus B except that it is provided with an aroma compound adsorbing device k1 branching from the top of the fragmenting device 11, in place of the aroma compound adsorbing device K.

Also like in Comparative Example 2, herein prepared was the aroma collecting apparatus b2 as Comparative Example 4, which is the same as the aroma collecting apparatus B except that it is provided with an aroma compound adsorbing device k2 branching from the middle of the first flow channel 1, in place of the aroma compound adsorbing device K.

Using each aroma collecting apparatus (B, b1 or b2), a part of minor fragments 22 were removed in the minor fragments preremoving device 12. The minor fragments 22 not removed in the minor fragments preremoving device 12 (mainly containing minor fragments derived from husks) were made to pass through the first flow channel 1 continuing from the minor fragments preremoving device 12 by the above-mentioned gas flow along with the gas inside the fragmenting device 11 being driven to fragment roasted cacao beans (the gas contains aroma compounds 21). By removal of the minor fragments 22 from the crude fragmented pieces of roasted cacao beans (crude fragmented pieces of animal and plant material 23), purified fragmented pieces of roasted cacao beans that were fragmented into a desired size can be obtained, and these can be stored in a chamber not shown and can be taken out of the aroma collecting apparatus B and stored therein until use thereof for producing cacao-flavored products.

After this process, in the same manner as in Example 3, the aroma compounds were collected from the aroma compound adsorbing device k1 (arranged at the top of the fragmenting device 11), the aroma compound adsorbing device k2 (arranged in the first flow channel 1), and the aroma compound adsorbing device K (arranged in the second flow channel 2), while the minor fragments derived from roasted cacao beans, husks and other foreign substances were removed from the gas.

According to the same process as in Example 2, aroma compound-containing cacao bean flavors (compositions each as a PG solution) were obtained to be a comparative product 10, a comparative product 11 and an invention product 4 (containing the aroma compounds collected from the aroma compound adsorbing device K).

Also in the same manner as in Example 2, a steam-distillation flavoring composition of roasted cacao beans was prepared to be a comparative product 12.

Next, 15 g of a commercially-prepared powdery cocoa drink was dissolved in 100 g of cold water or hot water, and the comparative product 10, 11, 12 or the invention product 4 was added thereto to have a concentration of 0.1% by mass.

These cocoa drinks were subjected to a sensory evaluation by well-trained 15 panelists in point of the flavor thereof. The sensory evaluation was made by 5-rank scores (lowest score 1, highest score 5) in point of the intensity of the aroma at the top and the roasty aroma of each product.

Average sensory evaluation results of the 15 panelists are shown in Table 6 below.

TABLE 6

| Type of Added Composition | | | |
|---|---|---|---|
| (type of aroma compound | | Aroma | |
| adsorbing device or steam | cold water/ | Intensity | Roasty |
| distillation) | hot water | at the Top | Aroma |
| Comparative Product 10 (k1) | cold water | 3.4 | 4.2 |
| | hot water | 2.6 | 3.0 |
| Comparative Product 11 (k2) | cold water | 3.8 | 4.4 |
| | hot water | 3.0 | 3.2 |
| Comparative Product 12 | cold water | 4.2 | 3.2 |
| (steam distillation) | hot water | 3.6 | 3.0 |
| Invention Product 4 (K) | cold water | 5.0 | 4.8 |
| | hot water | 4.8 | 4.8 |

As shown in the above Table 6, the cocoa drink added with the aroma composition of the invention product 4 gave a strong flavor at the top and the roasty aroma thereof was good, irrespective of the temperature of the cocoa drink to be added with the aroma composition, as compared with the cocoa drinks added with any of the compositions of the comparative products 10 to 12.

### Example 6

The aroma compositions of the present invention noticeably enhance the aroma at the top and improve the aroma sustainability as shown in Examples 1 to 5. Here, a test of confirming the relationship between the effect and the kind of the desorbent (that is, solvent for the aroma composition) was carried out.

According to the same process as in Example 5 but using ethanol for desorption in place of PG, aroma compounds emitted in fragmenting roasted cacao beans were collected to give an aroma compound-containing cacao bean flavoring composition (aroma composition as an ethanol solution) to be an invention product 5.

Next, 15 g of a commercially-prepared powdery cocoa drink was dissolved in 100 g of cold water or hot water to give cocoa drinks as controls. The invention product 4 (aroma composition as a PG solution) prepared in Example 5, the invention product 5, a 1/1 (by mass) mixture of the invention products 4 and 5, and the comparative product 12 (steam-distillation flavoring composition) prepared in Example 5 each were added to the resultant cocoa drinks to have a concentration of 0.1% by mass.

These cocoa drinks were sensoryally evaluated by well-trained 15 panelists in point of the flavor thereof. The sensory evaluation was made by scoring in point of the preference, the aroma at the top, and the aroma in the middle and later according to the standards mentioned blow. Average sensory evaluation results of the 15 panelists are shown in Table 7 below.

### (Sensory Evaluation Score)

### (1) Regarding Preference

5: Noticeably preferred to the control.
3: Relatively preferred to the control.
1: Preferred like the control.
0: Had an unfavorable flavor different from cocoa, and therefore not preferred to the control.

### (2) Regarding the Taste at the Top

5: Noticeably enhanced over the control, and gave a strong sweet and roasty aroma.
3: Somewhat enhanced over the control, and gave a sweet and roasty aroma.
1: Same level as that of the control.
0: Poor than the control, or had an unfavorable flavor different from cocoa.

### (3) Regarding the Taste in the Middle

5: Noticeably enhanced over the control, and gave a voluminous aroma and good aftertaste.
3: Gave a somewhat enhanced voluminous aroma and good aftertaste.
1: Same level as that of the control.
0: Poor than the control, or had an unfavorable flavor different from cocoa.

TABLE 7

| | Desorbent | | | | |
|---|---|---|---|---|---|
| | or Aroma | Amount Added (mass %) | | | |
| | Collection | | | | Comparative |
| Added Product | Method | Invention Product | | | Product |
| Invention Product 4 | PG | 0.1 | — | 0.05 | — |
| Invention Product 5 | EtOH | — | 0.1 | 0.05 | — |
| Comparative Product 12 | Steam | — | — | — | 0.1 |
| | Distillation | | | | |
| Sensory Evaluation | preference | 4.3 | 3.9 | 4.7 | 3.1 |
| Score | top | 4.0 | 4.4 | 4.4 | 3.5 |
| | middle and | 4.5 | 3.9 | 4.5 | 2.1 |
| | later | | | | |

* In the Table, the numerical value is % by mass relative to the total mass of the cocoa drink.
* EtOH means ethanol.

As shown in Table 7, it is confirmed that the cocoa drinks added with the invention products 4 and/or 5 are better than the cocoa drink added with the comparative product 12 in that the preference of the former is remarkably higher than that of the latter, the aroma at the top and in the middle and later of the former is sufficiently enhanced, and the top aroma intensity and the aroma sustainability of the former are excellent, all as compared with the controls. Further, it is confirmed that the cocoa drink added with a mixture of equal parts of the invention products 4 and 5 is extremely excellent in the aroma both at the top and in the middle and later.

### REFERENCE SIGNS LIST

1 First Flow Channel
2 Second Flow Channel
3 Guide Path
3A Inlet Port of Guide Path
3B Outlet Port of Guide Path
4 Linear Speed Controlling Device
11 Fragmenting Device
12 Minor Fragments Preremoving Device
13 Gas Flow Generating Device
14 Minor Fragments Removing Device
21 Aroma Compounds
22 Minor Fragments
23 Crude Fragmented Pieces of Animal and Plant Material
24 Exhaust Gas
K Aroma Compound Adsorbing Device
Ka1, Ka2 Mesh Lid
Kb Adsorbent Holder
k1 Aroma Compound Adsorbing Device Used in Comparative Example 1
k2 Aroma Compound Adsorbing Device Used in Comparative Example 2

1. A method for producing an aroma composition from an animal or plant material, which comprises:
fragmenting an animal or plant material to give crude fragmented pieces of the animal or plant material that contains minor fragments, and comprises:
removing minor fragments from a gas that contains aroma compounds emitted from the animal and plant material in fragmenting the animal and plant material and contains the minor fragments,
an adsorption step of applying the gas from which the minor fragments have been removed to an adsorbent to thereby make the aroma compounds adsorbed by the adsorbent, and
a collection step of collecting the aroma compounds from the adsorbent to prepare an aroma composition containing the aroma compounds, and in which:
the adsorbent is held in an adsorbent holder in an aroma compound adsorbing device, and the adsorbent holder has a mesh lid at both ends thereof in the gas flowing direction therethrough.

2. The method for producing an aroma composition from an animal or plant material according to claim 1, wherein removing the minor fragments from the crude fragmented pieces of the animal and plant material is carried out prior to the step of removing minor fragments from the gas.

3. The method for producing an aroma composition from an animal or plant material according to claim 1, wherein the step of removing the minor fragments is carried out in a minor fragments removing device.

4. The method for producing an aroma composition from an animal or plant material according to claim 1, wherein the gas flow is generated using a gas flow generating device.

5. The method for producing an aroma composition from an animal or plant material according to claim 1, wherein:
in the flow channel for the gas from which the minor fragments have been removed, a guide path that branches from the flow channel and is communicated with the aroma compound adsorbing device is provided, and
only a part of the gas from which the minor fragments have been removed is made to flow through the guide path and the adsorbent to collect the aroma compounds.

6. The method for producing an aroma composition from an animal or plant material according to claim 1, wherein the adsorbent is one or more selected from a styrene-divinylbenzene copolymer, an ethylvinylbenzene-divinylbenzene copolymer, a 2,6-diphenyl-9-phenyl oxide polymer, a condensation polymer of a methacrylic acid and a diol, and a modified silica gel.

7. The method for producing an aroma composition from an animal or plant material according to claim 1, wherein the aroma compounds are desorbed from the adsorbent using an organic solvent in the collection step.

8. The method for producing an aroma composition from an animal or plant material according to claim 7, wherein the organic solvent is ethanol or propylene glycol.

9. The method for producing an aroma composition from an animal or plant material according to claim 1, wherein the linear speed of the gas flowing into the absorbent is within a range of 0.1 to 35.0 m/s.

10. The method for producing an aroma composition from an animal or plant material according to claim 1, wherein the gas flowing direction is substantially an opposite direction to the direction of gravitational force.

11. The method for producing an aroma composition from an animal or plant material according to claim 1, wherein the aroma compound adsorbing device is a fluidized-bed column that holds the adsorbent therein.

12. The method for producing an aroma composition from an animal or plant material according to claim 1, which includes controlling the linear speed of the gas flowing into the adsorbent.

13. The method for producing an aroma composition from an animal or plant material according to claim 12, wherein the linear speed of the gas flowing into the adsorbent is controlled using a blower or a suction pump.

14. A food or drink containing an aroma composition produced according to the production method of claim 1.

15. An apparatus for collecting aroma from an animal plant material, which is provided with:
a device for fragmenting an animal or plant material,
a first flow channel which is communicated with the fragmenting device and through which a gas can flow, the gas containing aroma compounds emitted from fragmenting the animal or plant material and minor fragments,
a minor fragments removing device communicated with the first flow channel,
a second flow channel which is communicated with the minor fragments removing device and through which the gas, from which the minor fragments have been removed, can flow,
an aroma compound adsorbing device communicated with the second flow channel, and
a gas flow generating device that generates a gas flow continuing from the fragmenting device to the aroma compound adsorbing device, and in which:
the aroma compound adsorbing device has an adsorbent holder that holds an adsorbent therein, and the adsorbent holder has a mesh lid at both ends thereof in the gas flowing direction therethrough.

16. The apparatus for collecting aroma from an animal or plant material according to claim 15, which is further provided with a guide path branched from the second flow channel, and in which the guide path is communicated with the aroma compound adsorbing device.

17. The apparatus for collecting aroma from an animal or plant material according to claim 15, which is further provided with a minor fragments preremoving device between the fragmenting device and the first flow channel.

18. The apparatus for collecting aroma from an animal or plant material according to claim 15, wherein the gas flowing direction through the adsorbent is substantially an opposite direction to the direction of gravitational force.

19. The apparatus for collecting aroma from an animal or plant material according to claim 15, wherein the aroma compound adsorbing device is a fluidized-bed column that holds the adsorbent therein.

20. The apparatus for collecting aroma from an animal or plant material according to claim 15, which is further provided with a linear speed controlling device for controlling the linear speed of the gas from which the minor fragments have been removed.

21. The apparatus for collecting aroma from an animal or plant material according to claim 15, wherein the linear speed controlling device is a blower or a suction pump.

22. The apparatus for collecting aroma from an animal or plant material according to claim 15, wherein the diameter of the cross section of the adsorbent part held in the adsorbent holder is 10 mm or more.

23. The apparatus for collecting aroma from an animal or plant material according to claim 15, wherein the length in the gas flowing direction of the adsorbent part held in the adsorbent holder is 1000 mm or less.
